(19) United States
(12) Patent Application Publication
(10) Pub. No.: US 2009/0044222 A1
(43) Pub. Date: Feb. 12, 2009

(54) Broadcasting Receiver

(76) Inventors: Yoshihiro Machida, Yokohama (JP); Koji Kamogawa, Yokohama (JP); Kazunori Iwabuchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/179,601

(22) Filed: Jul. 25, 2008

(30) Foreign Application Priority Data
Aug. 9, 2007 (JP) 2007-207356

(51) Int. Cl. H04N 5/445; H04N 7/173

(52) U.S. Cl. 725/38; 725/131; 725/109

(57) ABSTRACT

A broadcasting receiver capable of receiving the broadcasting services via both broadcast wave and the Internet is provided, which may allow a user to select a desired broadcasting service irrespectively of the difference in transmission channel between the broadcast wave and the Internet. The broadcasting receiver includes a channel table to record at least a channel for the digital broadcasting service via the broadcast wave and a piece of access point name information for the digital broadcasting service via the Internet correspondingly to a channel number selected by a user, in which streaming data output of the tuner or the Internet communication device is selected based on the user's choice on the channel number. Further, when the same broadcasting service is provided via both the broadcast wave and the Internet, the broadcasting service of the better receiving condition is received.

### CLAIM OF PRIORITY

The present application claims priority from Japanese patent application serial No. JP2007-207356, filed on Aug. 9, 2007, the content of which is hereby incorporated by reference into this application.

### BACKGROUND OF THE INVENTION

(1) Field of the Invention

The present invention relates to a broadcasting receiver to receive broadcast materials via television broadcast wave and the Internet, which is characterized in facilitating programs selection by means of a remote controller and the like.

(2) Description of the Related Art

With such a conventional broadcasting receiver as receiving broadcast wave and outputting picture and sound signals, the channel selection among plural broadcasting services is carried out by pushing numerical buttons or a channel up/down button of a remote controller or the receiver itself. In more detail, such selection among plural broadcast waves is carried out by recording a frequency channel corresponding to a channel number of the remote controller and the like into a channel table within the receiver and specifying a frequency channel with reference to the channel table based on a channel number designated by pushing a specific button so as to select a specific broadcasting service.

Such a broadcasting receiver has been recently produced as being connected to the Internet so as to display thereon a Web page and information contained in an electronic mail as received, according to which receiver the pushing of an exclusive button thereof or of the remote controller changes to the mode in which such page and information are displayed. Thus, it requires a separate operation between a step of receiving broadcasting services via broadcast wave and a step of connecting the receiver to the Internet, which inconveniences the users.

In view of the above, in the JP-A 2002-44536, it is disclosed that a specific service provided upon the receiver being connected to the Internet is registered in a specific numerical button of the remote controller so as to generalize operability between the above-mentioned steps. More specifically, it is disclosed therein that program selection information such as a frequency channel is stored correspondingly to a channel number for the selection of the broadcasting services with the remote controller, for example, and a piece of program-related information to execute an intended processing program is stored correspondingly to such a channel number.

Thus, the pushing of a specific channel number button of the remote controller allows the processing program as registered to be executed. Especially, when a Web program and a URL are registered as such program-related information, the pushing of the specific channel numerical button of the remote controller permits a specific Web page to be displayed on the receiver.

### SUMMARY OF THE INVENTION

In addition to such communication services as providing Web pages and electronic mailing, the provision of the broadcasting services by way of the Internet has been recently in progress. With such broadcasting services provided by the Internet, it is arranged such that a receiver is connected to the portal site of a television broadcasting service provider and the channel selection is carried out by selecting a specific piece of link information as recorded in the Web page of the portal site so as to reproduce the streaming data of a picture file as selected.

For the users' conveniences' sake, it is preferred to generalize operability between broadcasting services by way of the Internet and those via broadcast wave. According to the disclosure of the above-mentioned JP-A 2002-44536, the recording of a Web program and a URL of the above-mentioned portal site as such program-related information allows the receiver to be connected to such a site by a remote controller.

However, since the selection of picture files as provided at the portal site is not performed, a so-called zapping by which broadcast pictures are sequentially displayed and a desired program is selected by means of a remote controller cannot be performed simultaneously with the provision of the broadcasting services via the Internet.

Further, upon a specific channel being selected, it requires the program to start along with reconnection to the Internet, so that it relatively takes a lot of time to complete such channel selection.

The present invention is to provide a broadcasting receiver that allows picture data as provided by broadcasting services to be selected as desired irrespectively of difference in transmission channel between broadcast wave and the Internet so as to be favorably convenient to use.

In order to solve the above prior issue, the broadcasting receiver according to the invention is characterized in including a tuner to receive a digital broadcasting service via broadcast wave and output picture and sound streaming data; an Internet communication device to receive a digital broadcasting service via the Internet and output the picture and sound streaming data; a remote controller for a user to select a desired broadcasting service; a channel receiver to receive a channel number for the digital broadcasting service selected with the remote controller; a channel table to record at least a channel of the digital broadcasting service via the broadcast wave and a piece of access point name information of the digital broadcasting service via the Internet correspondingly to the channel number; a channel controller to control one of the tuner and the Internet communication device based on the channel number with reference to the channel table; a data selector to select the picture and sound streaming data output by one of the tuner and the Internet communication device by means of the channel controller; and a decoder to decode the picture and sound streaming data selected by the data selector so as to output the corresponding picture and sound signals.

Herein, the channel table is arranged such that the channel table records the channel and the piece of access point name information providing the digital broadcasting service of same contents correspondingly to the same channel number, whereby the broadcasting service via one of the broadcast wave and the Internet is receivable based on the channel and the Internet access name information recorded in the channel table correspondingly to such same channel number.

Further, the channel controller is arranged herein such that it monitors the receiving condition of the broadcast wave and the Internet respectively and obtains the channel via the former and the Internet access name information providing the same broadcasting service with reference to the channel table upon a user's selection of a channel number so as to detect the broadcasting service of the better receiving condition for reception.

According to the invention, the channel selection may be carried out by pushing numerical buttons or a channel up-and-down button of the remote controller irrespectively of difference in transmission method between the broadcast wave and the Internet, which improves on the users' convenience to use.

### BRIEF DESCRIPTION OF THE DRAWINGS

These and other features, objects and advantages of the present invention will become more apparent from the following description taken in conjunction with the accompanying drawings wherein:

FIG. 1 is an explanatory view to show an arrangement of a first embodiment according to the invention;

FIG. 2 is an explanatory view to show a channel table according to the first embodiment;

FIG. 3 is an explanatory view to show an arrangement of a second embodiment according to the invention;

FIG. 4 is an explanatory view to show an arrangement of a third embodiment according to the invention;

FIG. 5 is an explanatory view to show a channel table of the third embodiment according to the invention;

FIG. 6 is an explanatory view to show a channel table of the third embodiment according to the invention;

FIG. 7 is an explanatory view to show an arrangement of a fourth embodiment according to the invention; and

FIG. 8 is an explanatory view to show a communication sequence according to a sixth embodiment of the invention.

### DETAILED DESCRIPTION OF THE EMBODIMENT

Hereinafter, the preferred embodiments of the invention are explained in more detail with reference to the accompanying drawings.

### First Embodiment

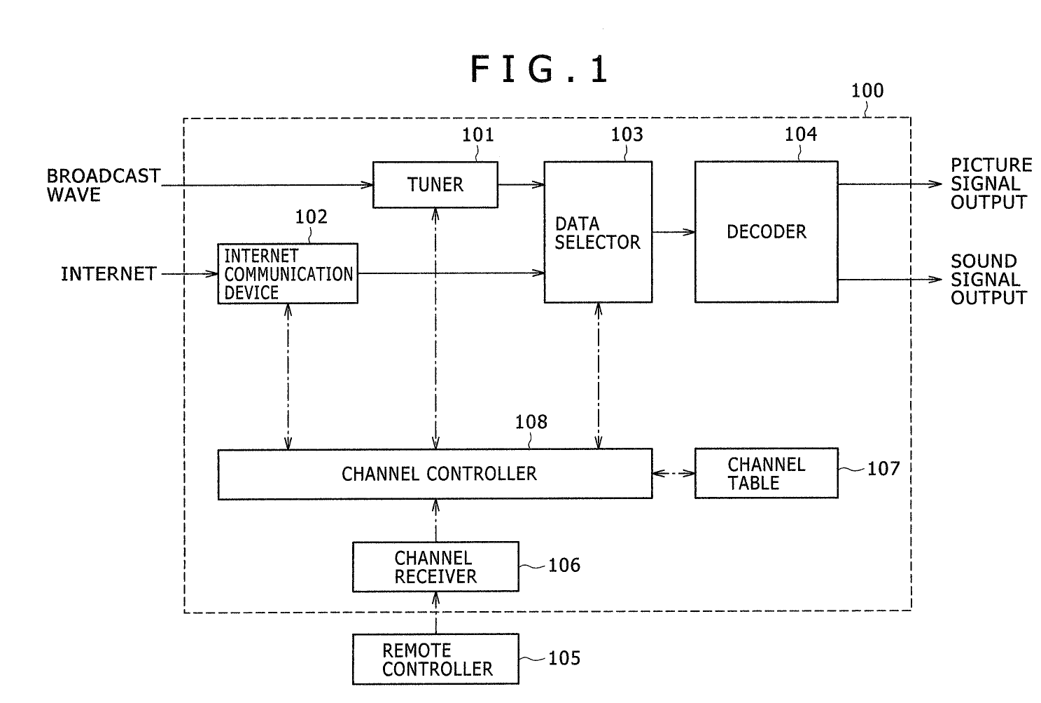

FIG. 1 shows a structural arrangement of a broadcasting receiver according to a first embodiment of the invention.

As shown, a broadcasting receiver 100 receives the picture and sound data of the broadcasting service by means of a tuner 101 to select a designated broadcasting channel and receive the broadcast wave to output compressed MPEG2-TS and an Internet communication device 102 to connect with the Internet and establish communication with a broadcasting service provider site so as to receive the picture and sound streaming data therefrom.

A data selector 103 selects the picture and sound streaming data output by either the tuner 101 or the Internet communication device 102 to supply a decoder 104 to decode such compressed picture and sound data with such streaming data. The decoder 104 makes a predetermined decoding operation to output picture and sound signals.

A remote controller 105 includes channel numerical buttons and a channel up-and-down button disposed thereon or in the proper broadcasting receiver 100, in which controller a channel number or a user's instruction on the channel number selection is input. The user's instruction output from the remote controller 105 is input to a channel receiver 106 to turn into a piece of control information for a channel controller 108 as set forth below.

The channel controller 108 reads a piece of broadcast wave tuning information or a piece of Internet access point name information from a channel table 107 as set forth below according to the user's instruction on the channel number or the channel number input from the channel receiver 106 and controls the tuner 101, the Internet communication device 102 and the data selector 103.

Herein, when the channel number is related with the broadcasting service via the broadcast wave, the controller obtains the broadcast wave tuning information and selects a channel with the tuner 101 under control and controls the data selector 103 such that it selects an input from the tuner 101. On the other hand, when it is related with the service via the Internet, the controller obtains the Internet access point name information and establishes communication with such access point with the Internet communication device 102 under control and controls the data selector such that it selects an input from the Internet communication device 102.

The Internet communication device 102 may simultaneously establish communication with plural the broadcasting services providing sites. A separate decoder 104 may be provided for each compression method of the picture and sound data. Also, the decoder 104 may have a function to decrypt the compressed and encrypted picture and sound data.

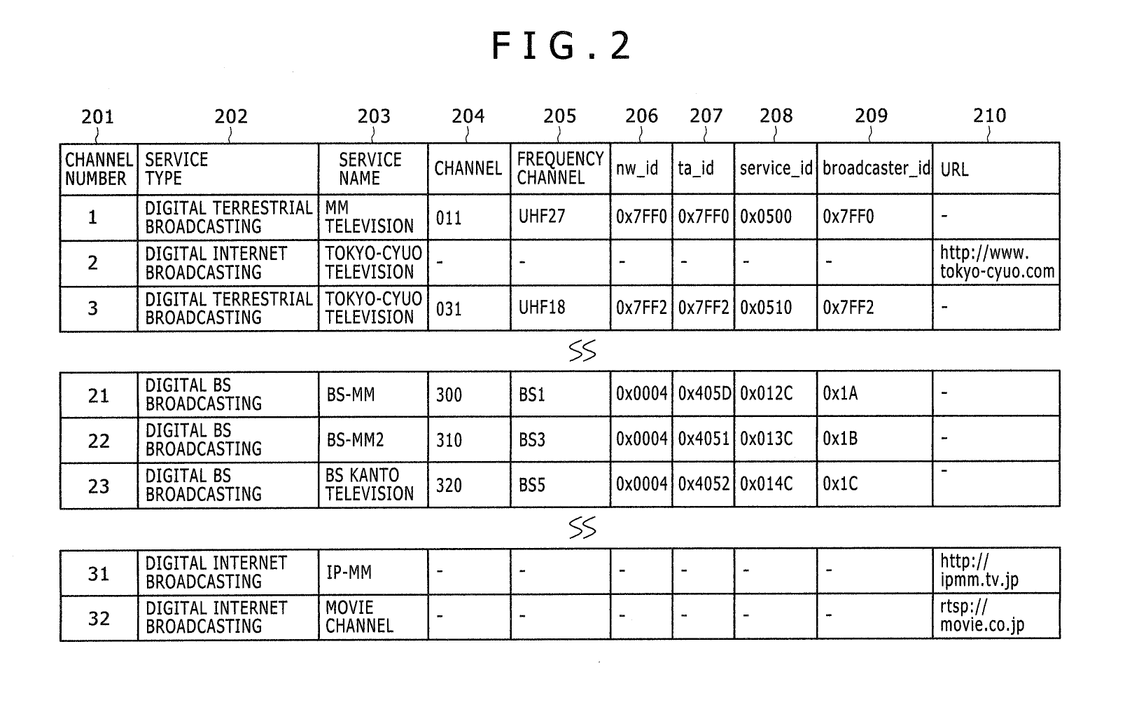

Then, the channel table 107 is explained in details with reference to FIG. 2.

There are recorded in the channel table 107 for each channel number 201 in series: a service type 202 to indicate such television broadcasting types as digital terrestrial television broadcasting, digital BS broadcasting and Internet broadcasting; a service name 203 to indicate a channel provider; a channel 204 to indicate the digital terrestrial television by a three digit number and the like; a frequency channel 205 to indicate a physical channel of the broadcast wave; a nw_id 206 to indicate a network identifier; a ts_id 207 to indicate a transport streaming identifier; a service_id 208 to indicate a service identifier; a broadcast_id 209 to indicate a broadcasting identifier; and a URL 210 to indicate an Internet access point name for the Internet television broadcasting.

To note, the nw_id 206 to indicate the network identifier, the ts_id 207 to indicate the transport streaming identifier, the service_id 208 to indicate the service identifier and the broadcast_id 209 to indicate the broadcasting identifier are regulated by e.g., Operational Guidelines TR-B14 for Digital Terrestrial Television Broadcasting compiled by Association of Radio Industries and Businesses in order to properly select a digital television broadcasting service containing compressed and multiplexed picture and sound data.

Then, the operational steps of a broadcasting receiver upon selecting a channel number according to the present embodiment are explained with reference to FIGS. 1 and 2.

To begin with, the operational steps to select a television broadcasting service channel via broadcast wave are explained as follows. When a user's pushes a numerical channel button ‘1’ of e.g., a remote controller 105, a piece of information that the button ‘1’ is pushed is notified to a channel receiver 106. In turn, the channel receiver 106 informs the channel controller 108 of the fact that a television broadcasting service whose channel number corresponds to ‘1’ is selected with the remote controller 105.

The channel controller 108 obtains a piece of table information whose channel number 201 corresponds to ‘1’ with reference to the channel table 107. It is exemplified in FIG. 2 that the channel controller 108 reads the service type 202 being of a digital terrestrial television broadcasting, the above-mentioned frequency channel 205 being UHF27, the above-mentioned nw_id 206 being 0x7FF0, the aforesaid ts_id 207 being 0x7FF0, the above-mentioned service_id 208 being 0x0500, the above-mentioned broadcast_id 209 being 0x7FF0 and the URL 210 being nothing.

Based on the service type 202 and the frequency channel 205 of the channel table 107, the channel controller 108 controls the tuner 101 such that the latter selects a desired channel and the data selector 103 such that it selects data input from the tuner 101. The decoder 104 decodes the picture and sound streaming data received via the broadcast wave and input from the data selector 103 to output the corresponding picture and sound signals.

Now, the operational steps to select a television broadcasting service channel number via the Internet are explained as follows. When a user's pushes a numerical channel button ‘2’ of e.g., a remote controller 105, a piece of information that the channel button ‘2’ is pushed is notified to the channel receiver 106. In turn, the channel receiver 106 informs the channel controller 108 of the fact that a television broadcasting service whose channel number corresponds to ‘2’ is selected with the remote controller 105.

The channel controller 108 obtains a piece of table information whose channel number 201 corresponds to ‘2’ with reference to the channel table 107. It is exemplified in FIG. 2 that the channel controller 108 reads the service type 202 being of Internet television broadcasting and the URL 210 to indicate the Internet television broadcasting access point name being http://www.tokyo-cyuo.com. Herein, the above-mentioned frequency channel 205, the above-mentioned nw_id 206, the above-mentioned ts_id 207, the above-mentioned service_id 208 and the above-mentioned broadcast_id 209 designate nothing.

Based on the service type 202 and URL 210 of the channel table 107, the channel controller 108 controls the Internet communication device 102 such that the latter establishes communication with a desired broadcasting service site and the data selector 103 such that it selects streaming data input from the Internet communication device 102. The decoder 104 decodes the picture and sound streaming data received via the Internet and input from the data selector 103 to output the corresponding picture and sound signals.

While the case where the numerical button of the remote controller 105 is pushed is exemplified above, the case where the operational steps of the channel up-and-down button thereof are taken is explained below. When either the channel up button or the channel down button of the remote controller is pushed, a piece of information that the channel up button or down button is pushed is notified to the channel receiver 106. In turn, the channel receiver 106 informs the channel controller 108 of the fact that the channel up button or down button of the remote controller 105 is selected.

The channel controller 108 stores the specific channel number 201 as selected at present among each channel number 201 in the table 107. When the channel controller 108 is notified of the channel up information by the channel receiver 106, it adds one to the value of the specific channel number 201 as stored so as to read a piece of table information on the corresponding channel number 201 from the channel table 107. On the other hand, when the channel controller 108 is notified of the channel down information by the channel receiver 106, it subtracts one from that of the specific channel number 201 as stored to read a piece of table information on the corresponding channel number 201 from the channel table 107.

To note, when the specific channel number 201 as stored is the largest value of the whole channel numbers, even upon the channel controller being notified of the channel up information, it does not add one thereto, but it defines ‘1’ for the channel number selection to read a piece of information on the channel number 1 from the whole channel numbers line-up 201. When the specific channel number 201 as stored corresponds to ‘1’, upon the channel controller being notified of the channel down information, it defines the largest value among the whole channel numbers line-up for the channel selection so as to read a piece of information on the largest channel number. Thereby, any channel number at 201 may be specifically designated with the channel up-and-down button of the remote controller. As for the channel up-and-down operation, a method of sequentially selecting the channel numbers of the same service type 202 is available.

According to the present embodiment, a broadcasting service may be selected with the numerical buttons or channel up-and-down button of the remote controller irrespective of difference in transmission channel between the broadcast wave and the Internet, which improves on the users' convenience to use.

### Second Embodiment

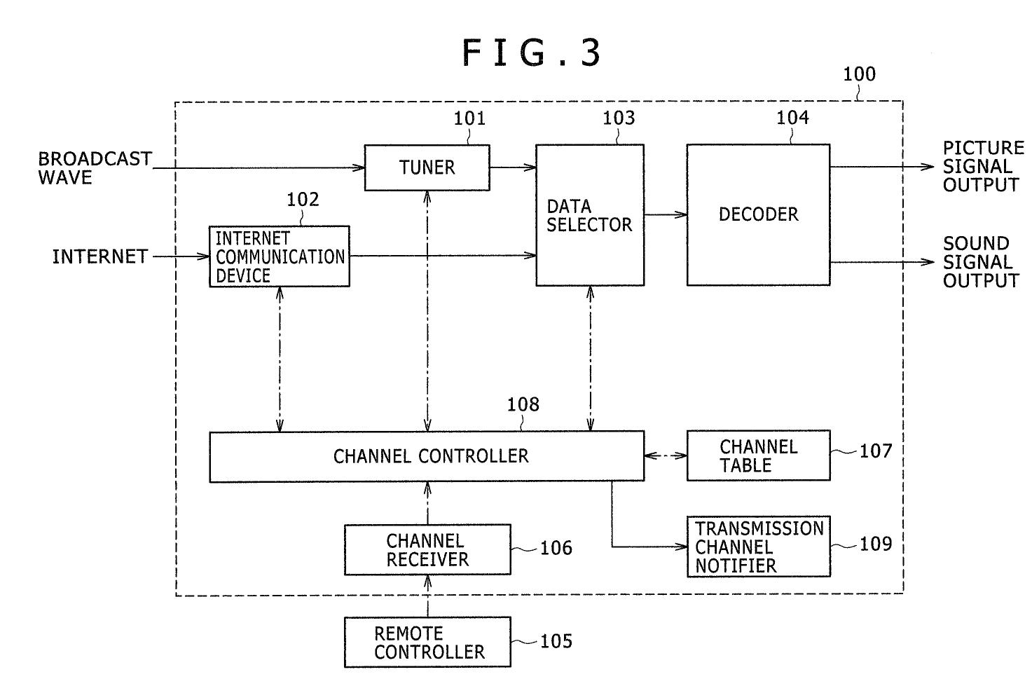

FIG. 3 shows a structural arrangement of a broadcasting receiver according to a second embodiment of the invention.

Only the difference from the above-mentioned first embodiment is noted below. A transmission channel notifier 109 as shown therein notifies on whether the transmission method of the picture and sound data output from the decoder 104 is via broadcast wave or the Internet through OSD (On Screen Display) or illuminating the proper LED, for example.

Then, the operational steps of the receiver are explained as follows. The channel controller 108 refers to the channel table 107 based on a piece of information delivered from the remote controller 105 and puts the data selector 103 under control subsequently to placing either the tuner 101 or the Internet communication device 102 under control so as to decide which transmission method is to be used for data transmission. Thereat, the channel controller 108 informs the transmission channel notifier 109 of which data transmission method is used, via broadcast wave or the Internet, according to which the notifier 109 informs the user of the type of transmission channel in use.

According to the present embodiment, the user may be aware of which data transmission method is selected, via broadcast wave or the Internet, which improves on the user's convenience to use.

### Third Embodiment

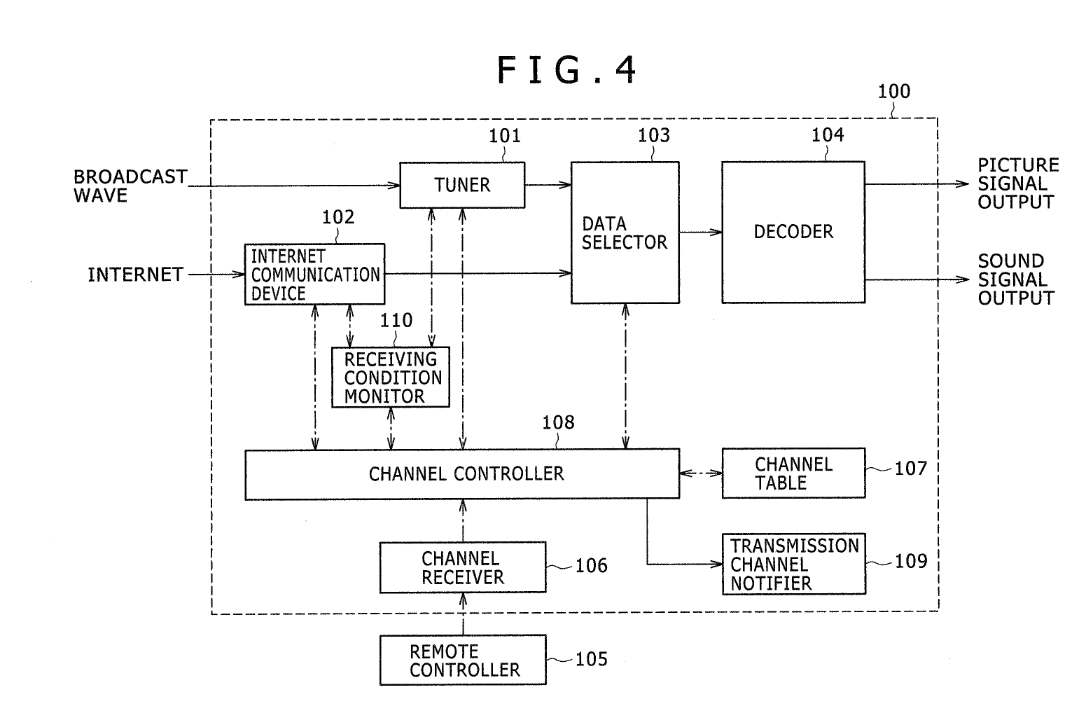

FIG. 4 shows a structural arrangement of a broadcasting receiver according to the present embodiment.

Only the difference with the second embodiment as described above is explained as follows. The tuner 101 as shown therein has a function to detect a data error rate within a certain duration of time or e.g., a BER (Bit Error Rate) indicating the receiving condition of the broadcast wave. Likewise, the Internet communication device 102 also has a function to detect a data error rate within certain duration of time, e.g., a packet error rate during communication. A receiving condition monitor 110 obtains a piece of information on the receiving condition such as an error rate from the tuner 101 and the Internet communication device 102 and notifies the channel controller 108 of the receiving condition of the respective transmission channels. The channel controller 108 puts picture and sound data output under control with reference to the channel table 107 and the receiving condition of the respective transmission channels.

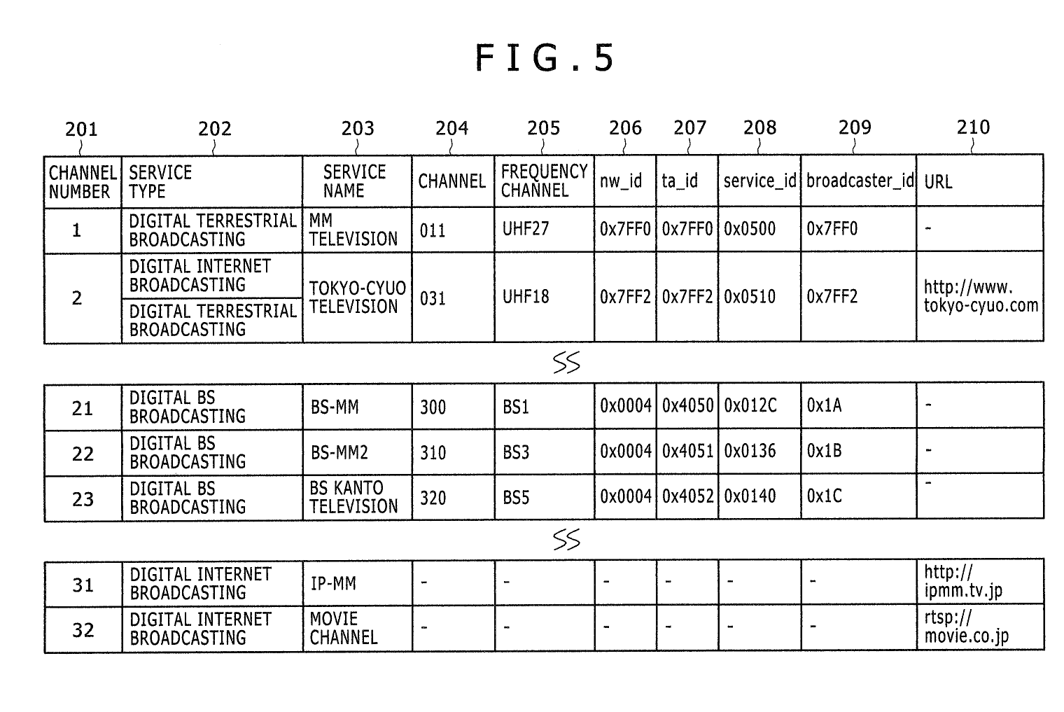

Then, the arrangement of the channel table 107 according to the present embodiment is explained with reference to FIG. 5.

It is assumed herein that the broadcasting service whose channel number 201 corresponds to 2 contains digital terrestrial television broadcasting and Internet television broadcasting services that share the same contents. As shown therein, both information on Internet television broadcasting and digital terrestrial television broadcasting services are contained in the service type, besides such information to select a channel via broadcast wave as the frequency channel 205 and such information on Internet broadcasting service as the URL 210.

Now, the operational steps of the receiver are explained in details as follows. When the user pushes the channel button ‘2’ of, for example, a remote controller 105, a piece of information that the channel button ‘2’ is pushed is notified to the channel receiver 106. In turn, the channel receiver 106 informs the channel controller 108 of the fact that the television broadcasting service whose channel number corresponds to 2 is selected with the remote controller 105.

The channel controller 108, with reference to the channel table 107, detects that there are two broadcasting services of digital terrestrial television and Internet television based on the table information on the channel number 2 among the whole channel line-up.

When the service type 202 is of digital terrestrial television broadcasting, the channel controller 108 reads the above-mentioned frequency channel 205 being UHF27, the above-mentioned nw_id 206 being 0x7FF0, the aforesaid ts_id 207 being 0x7FF0, the above-mentioned service_id 208 being 0x0500, the above-mentioned broadcast_id 209 being 0x7FF0 and the URL 210 being nothing, and controls the tuner 101 to select a desired channel.

When the service type 202 is of Internet television broadcasting, the channel controller reads the URL 210 being http://www.tokyo-cyuo.com and controls the Internet communication device 102 to establish communication with a desired broadcasting service providing site.

The receiving condition monitor 110 obtains a piece of numerical information on the receiving condition such as an error rate from the tuner 101 and the Internet communication device 102 so as to notify the channel controller 108 of the same.

The channel controller 108 standardizes the receiving condition of the broadcast wave and the Internet respectively as notified by the monitor 110 and selects, for example, a transmission method whose receiving condition is better with a lower error rate to control the data selector 103.

The decoder 104 decodes the compressed picture and sound data as input from the data selector 103 to output the corresponding picture and sound signals, with which channel number selection by the broadcasting receiver is over.

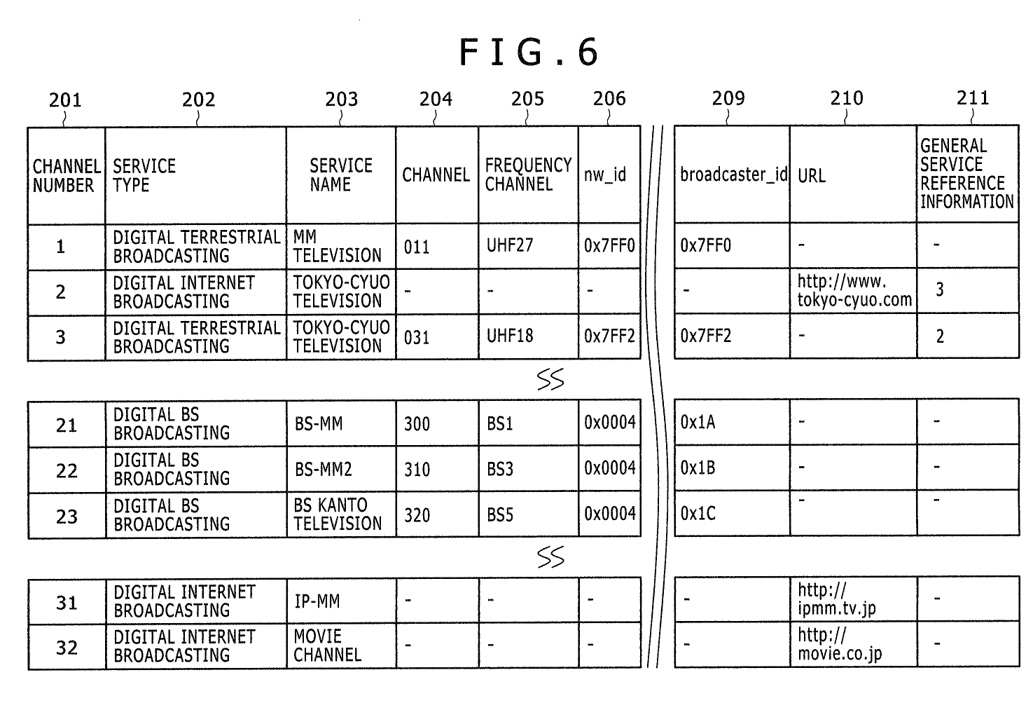

It is exemplified in FIG. 5 that the channel table 107 is arranged such that both pieces of television broadcasting service channels information via broadcast wave and Internet television broadcasting service access point name information are recorded therein together with the recording of plural service types for the sole channel number 201. However, the arrangement of the channel table 107 is not limited to the above, but may well be arranged as shown in FIG. 6.

In the channel table 107 as shown in FIG. 6, a piece of general service reference information 211 is provided for the respective channel numbers 201. When the same contents are shared between the digital terrestrial television broadcasting service and the Internet television broadcasting service, the respective services are registered in separate channel numbers 201. Another channel number in which the same contents providing service as a given channel number is registered is recorded in the general service reference information 211.

According to the above arrangement of the channel table 107, if such another channel number to be referred to is recorded in the general service reference information 211 when the channel controller 108 selects a channel number, it also reads a piece of information on such another channel number to select both channel numbers via broadcast wave and the Internet. Then, the channel controller standardizes the receiving condition of the broadcast wave and the Internet respectively as notified by the receiving condition monitor 110 and selects, for example, a transmission method whose receiving condition is better with a lower error rate to control the data selector 103.

To note, it is presumed herein that the same contents service is shared between the television broadcasting via broadcast wave and the Internet television broadcasting, in which it is supposed that means to detect whether or not the same contents service is shared between them may be set by the users themselves, or the broadcasting receiver automatically detects the same so as to record a piece of general information in the channel table with a developed exploitation of SI (Service Information) and PSI (Program Specific Information) provided in Programs Alignment Information in use for Digital Terrestrial Television Broadcasting STD-B10 compiled by Association of Radio Industries and Businesses.

According to the invention, the selection of the better receiving condition between the television broadcasting via broadcast wave and the Internet allows the better transmission method to be constantly selected.

### Fourth Embodiment

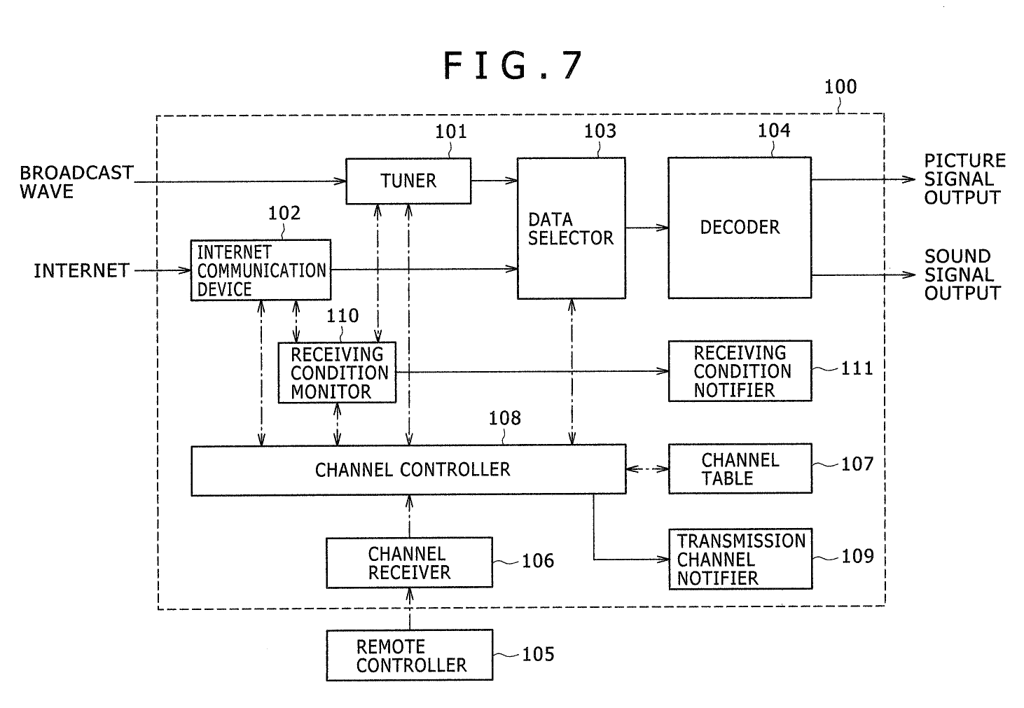

FIG. 7 shows a structural arrangement of a broadcasting receiver according to a fourth embodiment of the invention. Only the difference from the third embodiment is explained as follows.

The receiving condition monitor 110 as shown therein obtains a piece of numerical information on receiving condition from the tuner 101 and the Internet communication device 102 respectively to notify the receiving condition notifier 111 of the same. In turn, the receiving condition notifier 111 standardizes the receiving condition of the broadcast wave and the Internet respectively as notified from the monitor 110 to display such numerical information and so forth on the screen, i.e., notify on the same by OSD (On Screen Display) or with the proper LED illuminated.

Herein, the channel controller 108, unlike the third embodiment, may not automatically switch over one transmission method to the other according to the receiving condition notified from the monitor 110, but may stand by a user's switch-over.

According to the invention, advising the receiving condition of the transmission channel via the broadcast wave and the Internet respectively to a user allows him/her to select a transmission method of the better receiving condition.

### Fifth Embodiment

According to the above-mentioned embodiments, based on a user's instruction on the channel number selection, the channel controller 108 controls the Internet communication device 102 with reference to the channel table 107. The channel controller 108 according to the present embodiment reads the whole channel numbers corresponding to the Internet television broadcasting from the channel table 107. In more detail, the channel numbers 201 corresponding thereto are 2, 31 and 32 in FIG. 2. The channel controller 108 controls the Internet communication device 102 such that the latter establishes communication with the URLs 210 or Internet access point names of those channel numbers.

Upon the user' instruction thereon, the channel controller 108 obtains a piece of Internet access point name information in the same way as mentioned earlier so as to notify the Internet communication device 102 of the same. In turn, the Internet communication device 102 inputs to the data selector 103 a streaming data on the corresponding Internet access point name among plural the streaming data pieces being received from the URLs with which it has already established communication.

The Internet communication device 102 may obtain streaming data from plural predetermined Internet access point names and input such data obtained to the data selector 103, in which the data selector 103 supplies the decoder 104 with a streaming data corresponding to the channel number selected by an instruction from the channel controller 108 upon the user's selection thereon.

According to the present embodiment, automatically establishing communication with the respective URLs prior to the user's selection of a specific access point name enhances operational speed with which he/she selects a desired URL.

### Sixth Embodiment

In the above embodiments, it is exemplified that picture and sound streaming data is obtained based on a URL 210 that is an Internet access point name as registered in the channel table 107. Then, the renewal method of the channel table 107 upon an Internet access point name being subject to change is explained as follows.

The arrangement of the present embodiment is substantially the same as that of the first embodiment, so that only the difference with the latter is pointed out below. When the Internet communication device 102 has detected access point change such as an HTTP Redirect Code described in RFC2326 issued by IETF (Internet Engineering Task Force), it discerns whether such piece of access point name change information is temporary or permanent. When it is judged permanent, the Internet communication device notifies the channel controller 108 of such change along with a new access point name. Based on information notified by the Internet communication device, the channel controller 108 changes the corresponding piece of information recorded in the channel table 107. Concretely speaking, the contents of the relevant URLs 210 corresponding to the channel numbers 201 (as shown in FIG. 2) in issue are changed.

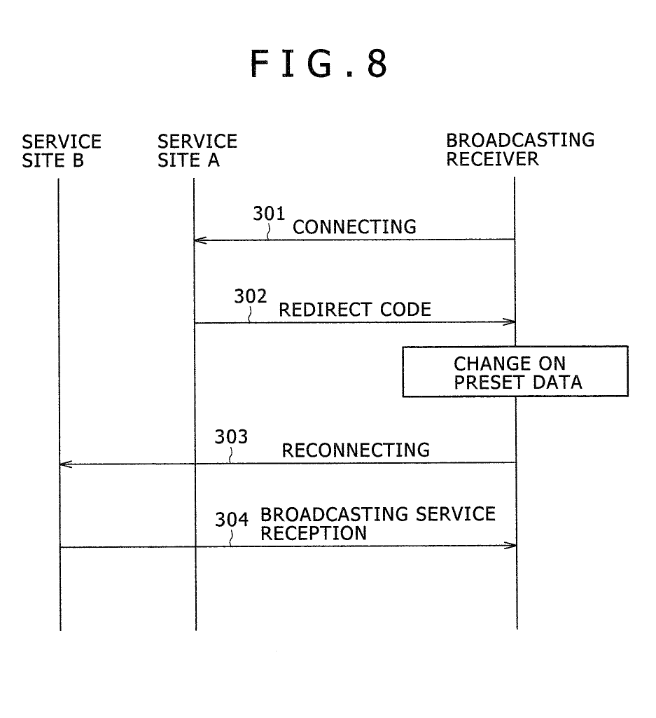

Then, with reference to FIG. 8, the communication sequence between the broadcasting receiver and the service sites is explained as follows. FIG. 8 shows an example of a sequence in which an Internet television broadcasting service channel number is selected.

To begin with, the channel controller 108 establishes communication 301 with a service site whose access point name is A. When a redirect code 302 and a URL to be redirected are returned by the service site-A, the channel controller 108 makes a change on the preset data of the channel table 107. Then, the channel controller 108 makes reconnection 303 to a service site-B to be redirected to permit a broadcasting service reception 304 from the site B.

According to the present embodiment, automatically detecting an Internet access point name change and reflecting the same on a piece of information of channel selection enhances operational speed with which a desired channel is selected.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A broadcasting receiver comprising:
a tuner to receive a digital broadcasting service via broadcast wave and output picture and sound streaming data;
an Internet communication device to receive a digital Internet broadcasting service and output the picture and sound streaming data;
a remote controller for a user to select a desired broadcasting service;
a channel receiver to receive a channel number for the digital desired broadcasting service as selected with the remote controller;
a channel table to record at least a channel of the digital broadcasting service via broadcast wave and a piece of access point name information of the digital broadcasting service via the Internet correspondingly to the channel number;
a channel controller to control one of the tuner and the Internet communication device based on the channel number with reference to the channel table;
a data selector to select the picture and sound streaming data output by one of the tuner and the Internet communication device by means of the channel controller; and
a decoder to decode the picture and sound streaming data selected by the data selector so as to output corresponding picture and sound signals.

2. The broadcasting receiver according to claim 1,
wherein the channel table records the channel and the piece of access point name information providing the digital broadcasting service of same contents correspondingly to the same channel number.

3. The broadcasting receiver according to claim 1,
wherein the channel table stores the digital broadcasting services respectively provided via the broadcast wave and the Internet correspondingly to the channel number of discrete value and is provided with a recording region for a piece of general service reference information in which the channel number of discrete value to provide the digital broadcasting service of same contents is recorded.

4. The broadcasting receiver according to claim 2,
wherein the channel controller, upon a user's designation of the channel number, obtains from the channel table the channel via the broadcast wave and the piece of access point name information via the Internet providing the digital broadcasting service of same contents and controls the tuner, the Internet communication device and the data selector so as to output the corresponding picture and sound signals of the digital broadcasting service of same contents via one of the broadcast wave and the Internet.

5. The broadcasting receiver according to claim 4 further comprising a receiving condition monitor to watch the receiving condition of the digital broadcasting service provided via the broadcast wave or the Internet, wherein the channel controller selects a transmission channel via one of the broadcast wave and the Internet whose receiving condition is better to provide the digital broadcasting service of same contents as registered in the channel table.

6. The broadcasting receiver according to claim 5,
wherein the receiving condition monitor derives a piece of information on the receiving condition from a BER (Bit Error Rate) of the broadcast wave that the tuner has detected and a packet error rate that the Internet communication device has detected so as to notify the channel controller of the information.

7. The broadcasting receiver according to claim 4 further comprising the receiving condition monitor to derive the piece of information on the receiving condition from the BER (Bit Error Rate) of the broadcast wave that the tuner has detected and the packet error rate that the Internet communication device has detected, and a receiving condition notifier to notify a user of the piece of information.

8. The broadcasting receiver according to claim 1,
wherein the channel controller, prior to a user's instruction on a channel number selection, obtains pieces of information on Internet access point names for a plurality of digital broadcasting services as registered in the channel table with reference to the table and instructs the Internet communication device to establish communication with the Internet access point names.

9. The broadcasting receiver according to claim 8,
wherein the channel controller, upon the user's instruction on the channel number selection, notifies the Internet communication device of the Internet access point name corresponding to the channel number, and the Internet communication device outputs to the data selector the picture and sound streaming data of the Internet access point name notified by the channel controller and extracted from the Internet access point names for the plurality of digital broadcasting services with which the Internet communication device has established communication.

10. The broadcasting receiver according to claim 8,
wherein the channel controller, upon the user's instruction on the channel number selection, notifies the data selector of the Internet access point name corresponding to the channel number, the Internet communication device obtains a plurality of the picture and sound streaming data pieces from the Internet access point names for the plurality of digital broadcasting services with which the Internet communication device has established communication so as to output the data to the data selector, and the data selector outputs to the decoder the picture and sound streaming data of the Internet access point name notified by the channel controller and extracted from the plurality of picture and sound streaming data pieces.

11. The broadcasting receiver according to claim 1 further comprising a transmission channel notifier to notify a user whether the broadcasting service received is via the broadcast wave or the Internet.

12. The broadcasting receiver according to claim 1,
wherein the piece of Internet access point name registered in the channel table is renewed to another Internet access point name designated by an http redirect code, when the Internet communication device has detected the http redirect code.
